(19) United States
(12) Patent Application Publication
(10) Pub. No.: US 2009/0241318 A1
(43) Pub. Date: Oct. 1, 2009

(54) Laminate armor system for police vehicle

(76) Inventor: Fredrick T. Howard, Surprise, AZ (US)

Correspondence Address: TOD R NISSLE, PO BOX 55630, PHOENIX, AZ, 85078, US

(21) Appl. No.: 12/378,027

(22) Filed: Feb. 10, 2009

Related U.S. Application Data
(63) Continuation-in-part of application No. 12/069,485, filed on Feb. 11, 2008.

(51) Int. Cl. B23P 11/00

(52) U.S. Cl. 29/428

(57) ABSTRACT

A method to protect a police officer receiving small arms fire utilizes a pliable armor sheet of interconnected, hinged, articulating panels. During construction of a police vehicle outwardly curving convex panel windows are utilized and made from tempered glass or from laminated glass including an outer convex surface, a first glass panel, a second glass panel, and a polymer sheet intermediate said first and second glass panels. The armor sheet is mounted in a dispensing unit housing in a wound configuration in said driver's side door for deployment therefrom at an angle canted inwardly toward said interior of said frame, to contact directly with said outer convex surface of a convex window in the driver's side door to form a canted convex small arms fire-resistant laminate comprising the armor sheet and the window in the driver's side door.

This application is a continuation-in-part of U.S. patent application Ser. No. 12/069,485 filed Feb. 11, 2008.

This invention pertains to a system to protect police vehicles from ammunition fired from pistols, rifles, or other small arms.

In particular, the invention pertains to a system of the type noted in which a glass laminate is formed to deflect or minimize the penetration of small arms fire.

Incidents occur regularly in which individuals direct small arms fire at police officers and at the vehicles in which police officers travel. Such incident occur on a regular basis in certain areas in some cities in the United States.

Accordingly, it would be highly desirable to provide an system to protect police officers and vehicles from small arms fire and to reduce the likelihood that a police offer will be injured by small arms fire.

Therefore, it is a principal object of the invention to provide an improved apparatus and method to minimize the effectiveness of small arms fire when directed at a police officer or vehicle.

This and other, further and more specific objects and advantages of the invention will be apparent from the following detailed description of the invention, taken in conjunction with the drawings, in which:

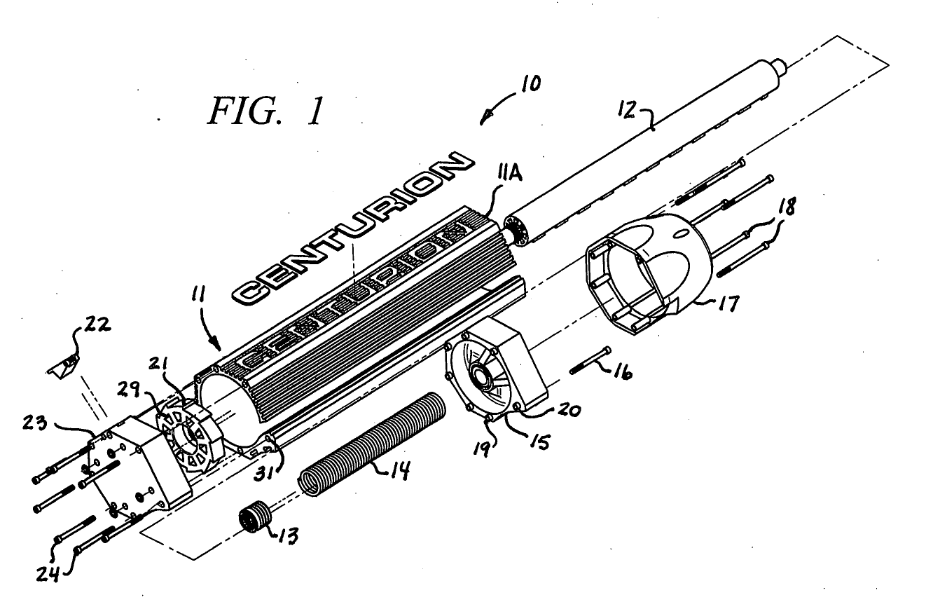

FIG. 1 is an exploded view illustrating in part a dispensing unit for storing and deploying one component of the glass laminate system of the invention;

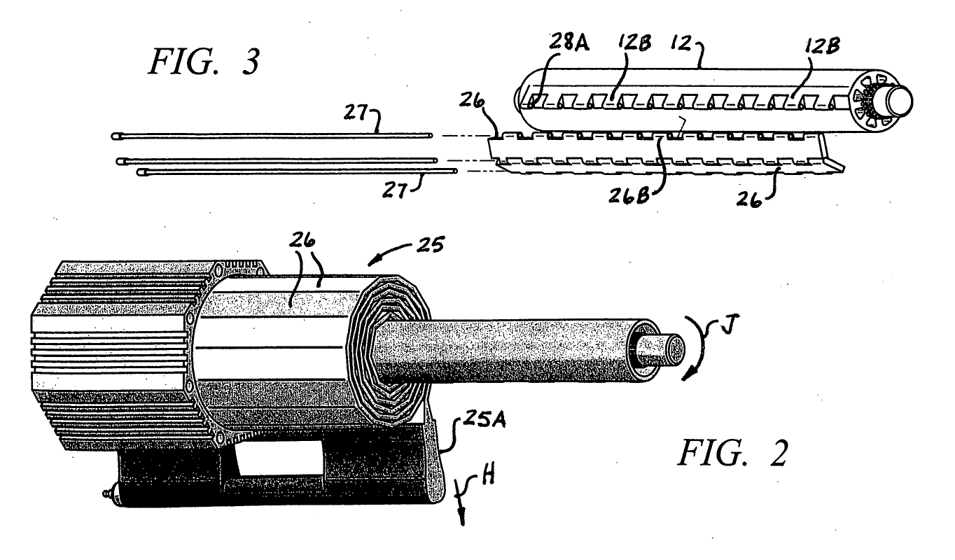

FIG. 2 is a cut away perspective view illustrating a portion of the dispensing unit of FIG. 1 with the hinged, articulating armor sheet mounted on and stored in the dispensing unit;

FIG. 3 is a perspective view illustrating hinged segments of the articulating armor sheet;

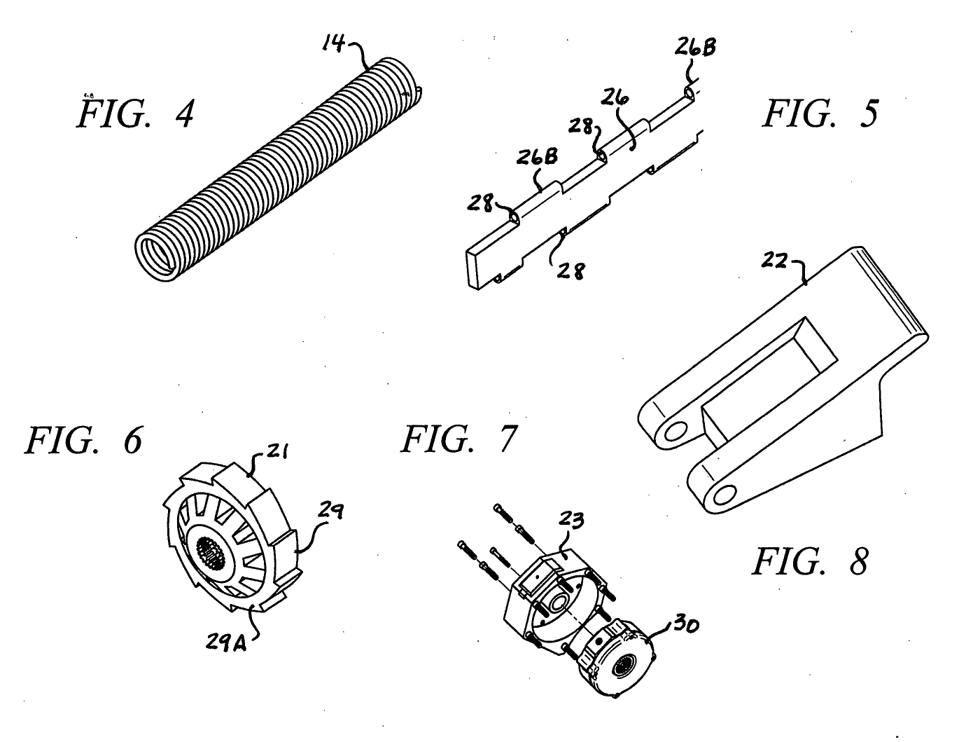

FIG. 4 is a perspective view illustrating a spring utilized in the dispensing unit of FIG. 1;

FIG. 5 is a perspective view illustrating a hinged segment of the articulating armor sheet mounted on the dispensing unit of FIGS. 1 and 2;

FIG. 6 is a perspective view illustrating a spring gear component utilized in the dispensing unit of FIG. 1;

FIG. 7 is a perspective view illustrating a motor assembly construction that is used in one embodiment of the invention;

FIG. 8 is a perspective view illustrating a spring cap latch component used in the dispensing unit of FIG. 1;

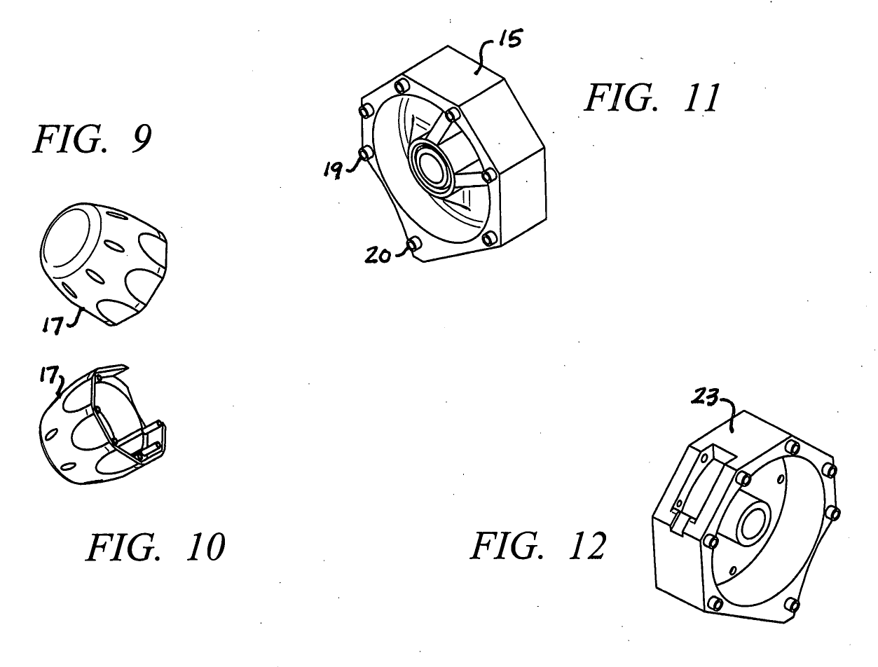

FIG. 9 is a perspective view illustrating an aerodynamic cap used in the dispensing unit of FIG. 1:

FIG. 10 is a perspective view further illustrating the aerodynamic cap of FIG. 9;

FIG. 11 is a perspective view illustrating a cylinder cap-torsion spring receiver used in the dispensing unit of FIG. 1;

FIG. 12 is a perspective view illustrating a cylinder gear cap used in the dispensing unit of FIG. 1;

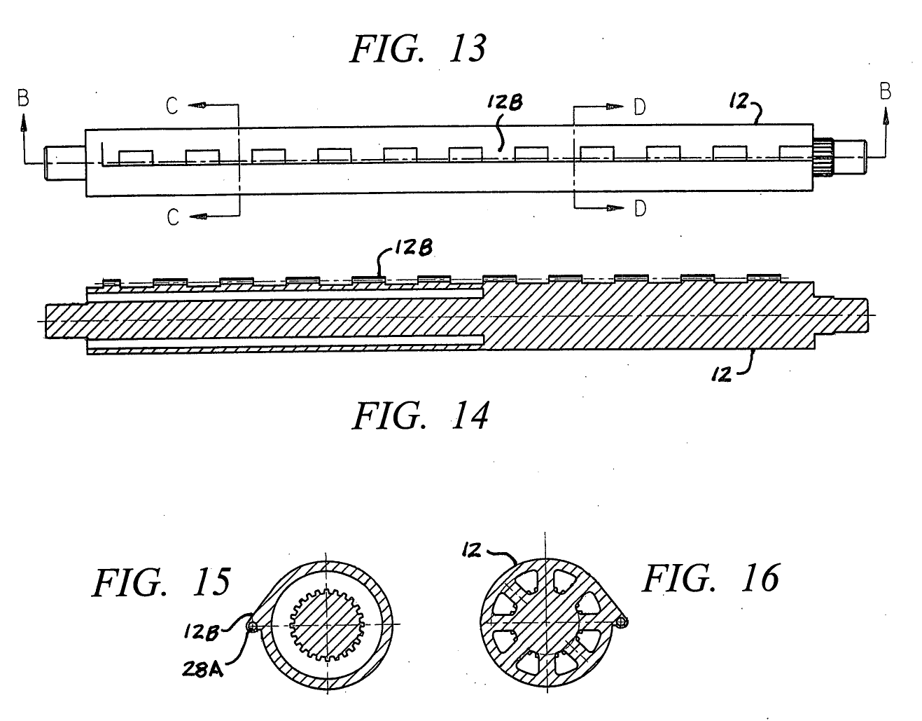

FIG. 13 is a side elevation view illustrating an axle core used in the dispensing unit of FIG. 1;

FIG. 14 is a section view illustrating the axle core of FIG. 13 taken along section line B-B thereof;

FIG. 15 is a section view illustrating the axle core of FIG. 13 taken along section line C-C thereof;

FIG. 16 is a section view illustrating the axle core of FIG. 13 taken along section line D-D thereof;

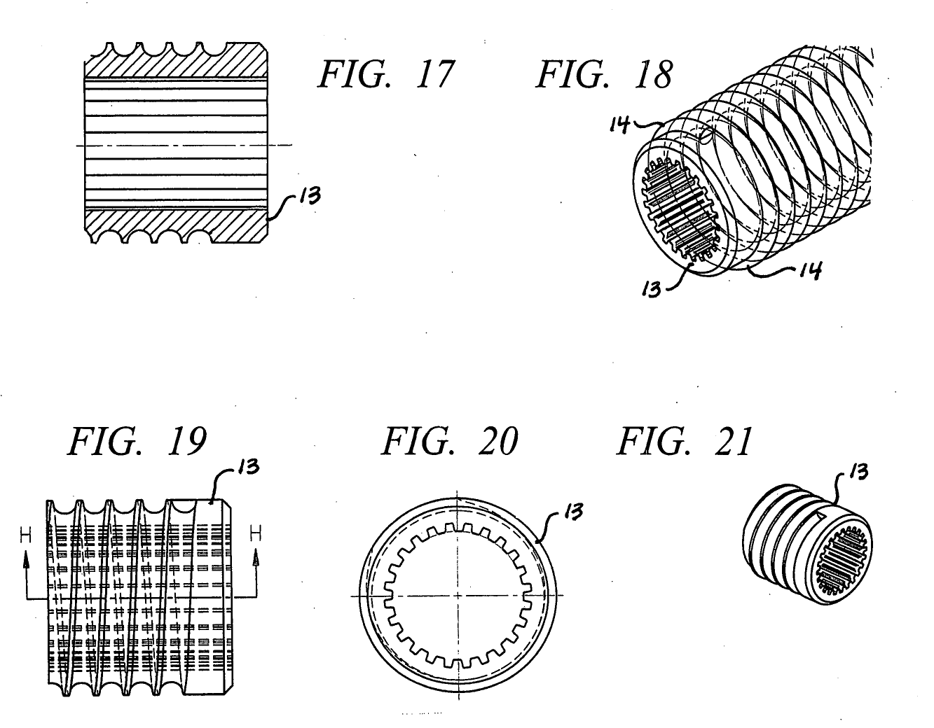

FIG. 17 is a section view illustrating the retractor spring nut of FIG. 19 taken along section line H-H thereof;

FIG. 18 is a perspective view illustrating the retractor spring nut of FIGS. 17, 19 to 21 installed in the end of the spring of FIG. 4;

FIG. 19 is a side view illustrating a retractor spring nut used in the dispensing unit of FIG. 1;

FIG. 20 is a front view illustrating the retractor spring nut of FIG. 19;

FIG. 21 is a perspective view illustrating the retractor spring nut of FIG. 19;

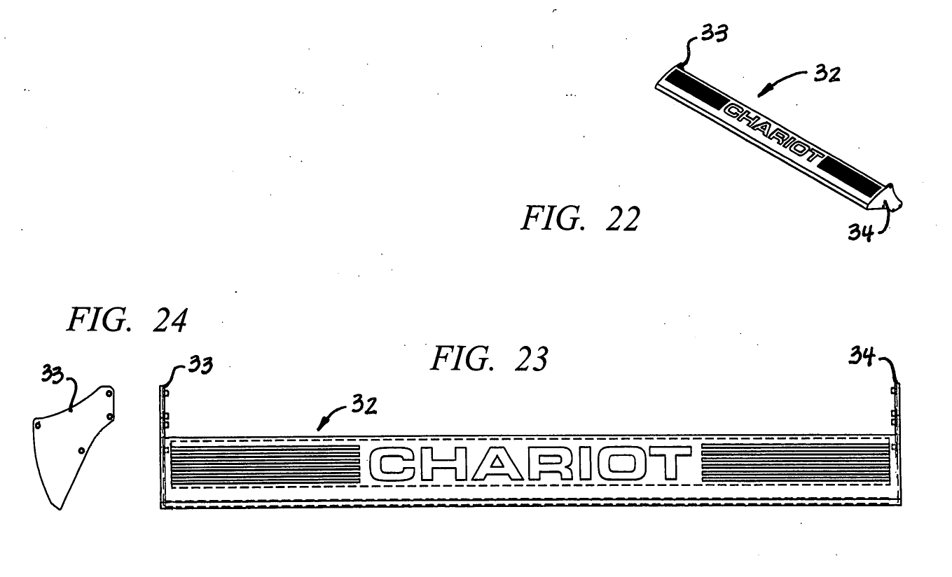

FIG. 22 is a perspective view illustrating a wind shield that can be utilized in combination with the dispensing unit of FIG. 1;

FIG. 23 is a tip view further illustrating the wind shield of FIG. 22;

FIG. 24 is an end view illustrating the wind shield of FIG. 23;

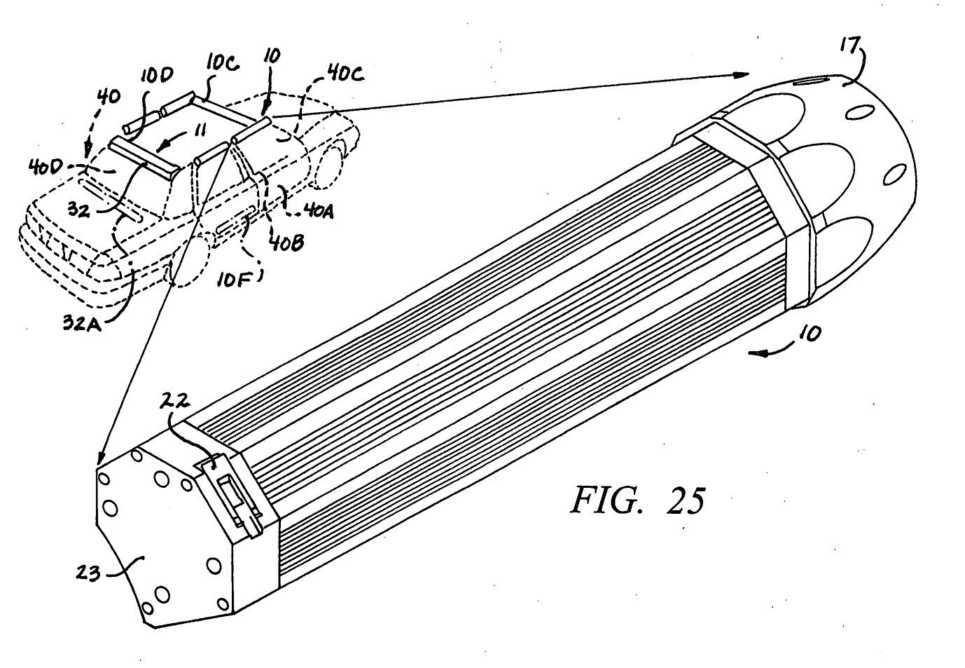

FIG. 25 is a perspective view illustrating the dispensing unit of FIG. 1 assembled and mounted on a police vehicle;

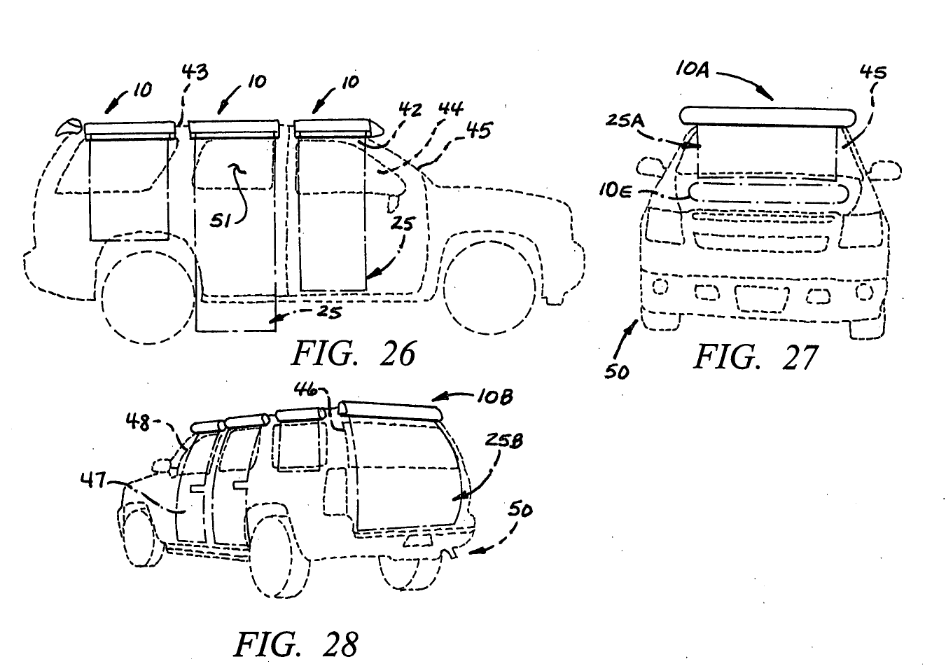

FIG. 26 is a side elevation view illustrating dispensing unit of the type depicted in FIG. 1 mounted at several locations on the side of a police vehicle;

FIG. 27 is a front view illustrating a dispensing unit of the type depicted in FIG. 1 mounted on the front of a police vehicle;

FIG. 28 is a perspective view illustrating the police vehicle of FIG. 26 with dispensing units of the type depicted in FIG. 1 mounted thereon;

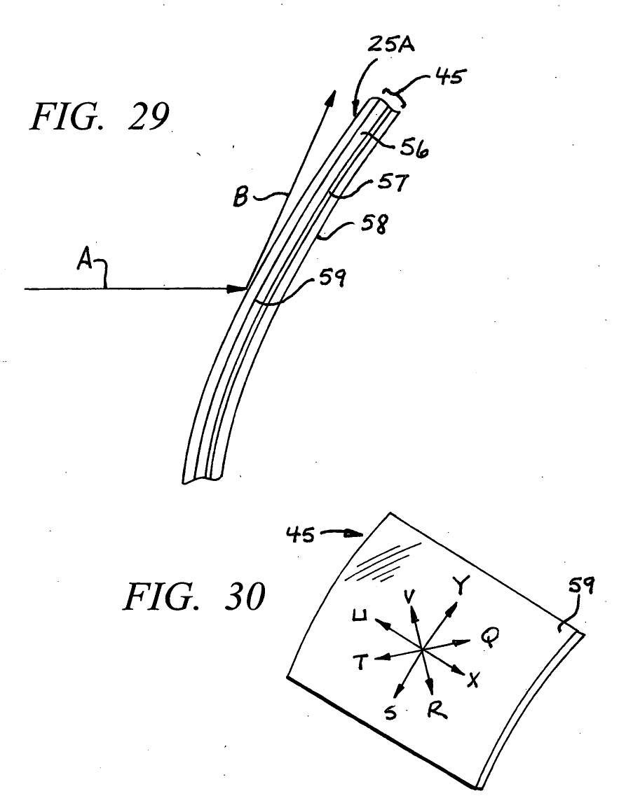

FIG. 29 is a partial side view of glass laminate of the invention illustrating of the mode of operation thereof; and,

FIG. 30 is a perspective view of a glass panel utilized in the glass laminate of the invention and illustrating the mode of operation thereof.

Briefly, in accordance with the invention, I provide an improved method to protect a police officer receiving small arms fire. The method comprises the steps of providing a motorized police vehicle including a frame having an interior and a front, a plurality of ground engaging wheels rotatably attached to the frame and suspending the frame above the ground, a driver's side door having a top, a first window mounting space in said door beneath said top of said door, and a windshield mounting space in said front of said frame and having a top; mounting a first window in the first window mounting space such that the window is canted inwardly toward the interior, the window comprising a convex panel of glass including an outer convex surface and selected from tempered glass and laminated glass; mounting a second window in the windshield mounting space such that the second window is canted inwardly toward the interior, the second window comprising a convex panel of glass selected from tempered glass and from laminated glass including an outer convex surface, a first glass panel, a second glass panel, and a polymer sheet intermediate the first and second glass panels; providing at least one dispensing unit including a pliable armor sheet of interconnected, hinged, articulating panels wound and stored in the dispensing unit for deployment therefrom at an angle canted inwardly toward the interior of the frame, to contact directly with the outer convex surface of one of a first pair comprising the first window and the second window, and to form a canted convex small arms fire-resistant laminate comprising the armor sheet and the one of the first and second windows; mounting the dispensing unit on one of a second pair comprising the top of the driver's side door and the top of the windshield mounting space, the dispensing unit extending outwardly from the frame and visible from the exterior of the vehicle; driving the police vehicle to a location where small arms fire will be directed toward said vehicle; positioning the police vehicle such that the pliable sheet when deployed from the dispensing unit will receive at least some of the small arms fire directed toward the vehicle; and, deploying the pliable sheet from the dispensing unit to extend over and directly contact the convex outer surface of at least one of the first pair to form the canted convex small arms fire-resistant laminate.

In another embodiment of the invention, I provide an improved method to protect a police officer receiving small arms fire. The method comprises the steps of providing a pliable armor sheet of interconnected, hinged, articulating panels; manufacturing a driver's side door having a top, a window mounting space in the door beneath the top of the door, and a dispensing unit housing; providing a motorized police vehicle including a frame having an interior and a front, a plurality of ground engaging wheels rotatably attached to the frame and suspending the frame above the ground, and a windshield mounting space in the front of the frame and having a top; mounting the driver's side door in the police vehicle; mounting a first window in the window mounting space such that the window is canted inwardly toward the interior, the window comprising a convex panel of glass, including an outer convex surface, and selected from one of a pair comprising tempered glass, and laminated glass including an outer convex surface, a first glass panel, a second glass panel, and a polymer sheet intermediate the first and second glass panels; mounting a second window in the windshield mounting space such that the second window is canted inwardly toward the interior, the window comprising a convex panel of glass, including an outer convex surface, and selected form one of a pair comprising tempered glass, and laminated glass including an outer convex surface, a first glass panel, a second glass panel, and a polymer sheet intermediate the first and second glass panels; mounting the pliable armor sheet in the dispensing unit housing in a wound configuration in the driver's side door for deployment therefrom at an angle canted inwardly toward the interior of the frame to direct contact directly with the outer convex surface of one of a first pair comprising the first window and the second window, and to form a canted convex small arms fire-resistant laminate comprising the armor sheet and the one of the first and second windows; driving the police vehicle to a location where small arms fire will be directed toward the vehicle; positioning the police vehicle such that the pliable sheet when deployed from the dispensing unit will receive at least some of the small arms fire directed toward the vehicle; and, deploying the pliable sheet from the dispensing unit to extend over and directly contact the convex outer surface of at least one of the first pair to form the canted convex small arms fire-resistant laminate.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a dispensing unit generally indicated by reference character 10. Dispensing unit 10 stores and deploys a pliable armor sheet 25. Sheet 25 is, for the sake of clarity, omitted from FIG. 1, but is illustrated in FIGS. 2 and 3.

In FIG. 1, dispensing unit 10 includes hollow housing 11, spring gear cap 23, gear latch 22, spring lock gear 21 with outer face 29, axle core 12, retraction spring nut 13, retraction spring 14, spring cap 15, and aerodynamic cap 17. Bolts 16 extend through apertures 20 formed through cap 15 and turn into internally threaded apertures (not visible) in end 11A of housing 11 to secure cap 15 to end 11A. Bolts 18 extends through apertures formed in cap 17, through apertures 19 formed in cap 15, and turn into internally threaded apertures (not visible) formed in end 11A to secure cap 17 to end 11A and cap 15. Similarly, bolts 24 extend through apertures formed in cap 23 and turn into internally threaded apertures 31 formed in end 11B of housing 11 to secure cap 23 to end 11B.

When armor sheet 25 is mounted on axle core 12 in the manner illustrated in FIG. 2, sheet 25 is wound on axle core 12 in a storage configuration substantially inside housing 11. Sheet 25 is deployed by manually operating dispensing unit 10 in a manner similar to that of a spring loaded window shade; namely, handle 25A of sheet 25 is grasped and pulled downwardly in the direction of arrow H to cause axle core 12 to rotate in the manner indicated by arrow J so that sheet 25 downwardly unwinds from axle core 12 in the direction of arrow H and sheet 25 moves to a deployed configuration illustrated in FIG. 26. After sheet 25 is in the deployed position, it is retracted to the storage configuration of FIG. 2 by manipulating latch to disengage it from spring lock gear 21 so that spring 14 causes axle core 12 to rotate in a direction opposite that indicated by arrow J so that core 12 pulls sheet 25 back inside housing and rewinds sheet 25 about core 12. Any desired construction of unit 10 can be utilized to enable the deployment and retraction of sheet 25.

While armor sheet 25 can be constructed in any desired manner using any desired material(s), the hinged articulating configuration depicted in FIGS. 2 and 3 is presently preferred. Sheet 25 is constructed of a plurality of elongate panels 26 hinged together by elongate pins 27 that each extend through apertures 28 (FIG. 5) formed through outwardly extending spaced apart fingers 26B (FIG. 5) on a first panel that interfit with comparable outwardly extending spaced apart fingers 26B on another adjacent second panel 26 such that apertures 28 in the first panel are in registration and aligned with apertures 28 in the second panel so that a pin 27 can extend through said aligned apertures to interconnect pivotally the first and second panels 26 (and to similarly pivotally, hingedly connect each other adjacent pair of panels 26 comprising articulating sheet 25). In addition, as is illustrated in FIG. 3, axle core 12 includes a plurality of outwardly extending spaced apart fingers 12B which interfit with comparable outwardly extending spaced apart fingers 26B on a panel 26 so that apertures 28A in said fingers 12B of said axle core are in registration and alignment with apertures 28 in the outwardly extending fingers 26B of the panel 26, and a pin can be inserted into said aligned apertures 28, 28A to interconnect pivotally the panel 26 with core 12. Panels 26 are presently preferably fabricated from stainless steel.

Additional views of spring 14, panel 26, spring lock gear 21 (with inner face 29A), gear latch 22, aerodynamic cap 17, spring cap 15, and spring gear cap 23 are illustrated in FIGS. 4, 5, 6, 8, 9, 11, and 12, respectively. Cap 17 is also further illustrated in FIG. 10.

FIG. 7 illustrates in part another embodiment of the invention in which a motor 30 is mounted in spring gear cap 23 and is utilized to engage and turn axle core 12 instead and in place of spring 14.

FIGS. 13 to 16 illustrate in greater detail axle core 12.

FIGS. 17 to 21 illustrate in greater detail retraction spring nut 13. In FIG. 18, nut 13 is mounted in one end of spring 14.

FIGS. 22 to 24 illustrate a wind shield 32 that can be mounted on housing 11 in the manner indicated in FIG. 25 in order to reduce the wind resistance of housing 11. A shield 32 can take on any desired shape and dimension in order to reduce the aerodynamic drag created by a unit 10 when unit 10 is mounted on a police vehicle 40 or other vehicle and the vehicle is moving.

Potential locations of a dispensing unit 10 on a police vehicle, military vehicle, or other vehicle are illustrated in FIG. 25. One location for a dispensing unit 10 is on top of a door 40A. Door 40A includes a horizontally disposed frame member (not visible in FIG. 25) that extends over and above an opening 40B formed in door 40A to receive a window 40C. Unit 10 is attached to and mounted on this horizontally disposed frame member. Consequently, unit 10 is horizontally disposed when it is mounted on door 40A. In FIG. 25, each unit 10 on vehicle 40 is horizontally disposed and, accordingly, armor sheet 25 in each unit 10 is deployed by pulling sheet in a generally vertical direction downwardly toward the ground. Some vehicles have doors in which the upper edge of the window is the “top” of the door. In such vehicles, a unit 10 can be vertically disposed (i.e., rotated ninety degrees from the orientation of FIG. 25) and mounted on one side of the door (instead of being mounted on the top or bottom of the door). When unit 10 is mounted in such a vertical orientation, then when sheet 25 is deployed, it is pulled in a horizontal direction of travel that is generally parallel to the ground.

Another potential location for a dispensing unit 10 is indicated in FIG. 25 by reference character 10C and is on the roof of vehicle 40 above and adjacent the top of the front windshield.

A further potential location for a dispensing unit 10 is indicated in FIG. 25 by reference character 10D and is on the roof of vehicle 40 above and adjacent the top of the rear window 40D.

Still another potential location for a dispensing unit 10 is indicated in FIG. 25 by reference character 32A and is on the trunk of vehicle 40 below and adjacent the rear window 40D. The armor sheet 25 in a unit 32A is deployed by pulling the armor sheet upwardly over the exterior of rear window 40D and by securing sheet 25 in such a deployed position. By way of example, and not limitation, one way to secure sheet 25 in such a deployed position is to attach the distal end of the sheet 25 to a fastener that is fixedly attached to the roof of vehicle 40.

Still a further potential location for a dispensing unit 10 is indicated in FIG. 25 by reference character 10F and is on the lower portion of a vehicle door. The armor sheet 25 in a unit 10F is deployed by pulling the armor sheet upwardly over the exterior of the vehicle door and of the window in the door and by securing sheet 25 in such a deployed position.

Yet still another potential location for a dispensing unit 10 is indicated in FIG. 27 by reference character 10E and is on the hood of a vehicle 50 adjacent and below the front windshield of vehicle 50. The armor sheet 25 is a unit 10E is deployed by pulling the armor sheet upwardly over the exterior of the front windshield and by securing sheet 25 is such a deployed position.

A dispensing unit 10 can be mounted or formed at the front or rear bumper, under the support frame, or at any desired location on a vehicle.

Further, the dispensing unit 10 can be provided with mounting brackets or other mounting systems that permit unit 10 to be readily mounted on and removed from the top of a door of an existing vehicle, from the roof of an existing vehicle, from the top of the trunk door of an existing vehicle, from the top of the hood on the front of an existing vehicle, or from any other desired location on a vehicle. Such a mounting system would facilitate the portability and transportation of a unit 10 inside the trunk or other portion of a vehicle such that unit 10 could be removed from the trunk and mounted on the top of a vehicle door or other location on the vehicle in emergency situations or when otherwise needed.

In FIGS. 25 to 28, the dispensing units 10C and 10D (FIG. 25), 10 (FIG. 26), 10B (FIG. 28), and 10A (FIG. 27) are mounted on the exterior of a vehicle. Such dispensing units can, if desired, be mounted on the interior of a vehicle such that the armor sheet 25 in each unit can be deployed inside the vehicle. Further, a dispensing unit 32A, 10F (FIG. 25) can be mounted inside a vehicle door, inside the paneling comprising the trunk hood, or inside another portion of the vehicle, in which case an armor sheet 25 is deployed through an opening formed in the door, trunk hood, etc. Further, when a vehicle door (or roof, trunk, etc.) is manufactured, a portion of the door can be integrally formed to function as a housing 11 in which in which the other components of unit 10 illustrated in FIG. 1 are mounted. Such an integrally formed housing in a door may be internal and not visible to an individual viewing the door, or, may be internal and form and cause an outwardly extending uncharacteristic contour to be produced on the door, which contour is recognizable by an individual viewing the door.

Unit 10 can be mounted such that sheet 25 can be deployed upwardly, downwardly, or laterally. For example, if unit 10 is mounted on the hood below the front windshield, sheet 25 can be deployed upwardly over the windshield and latched above the windshield on the roof of the vehicle. Any desired conventional or other latching mechanism can be utilized.

As can be appreciated, the length of a dispensing unit 10 (and the width of an armor sheet 25) can vary as desired. For example, a dispensing unit 10C positioned above the windshield or rear window 40D of a vehicle 40 can be longer than a dispensing unit 10 positioned above a door window 40C of a vehicle. Similarly, the length of an armor sheet 25 stored in a dispensing unit 10 can vary. Armor sheets 25, 25A of varying deployed lengths are illustrated in FIG. 26.

In FIGS. 26 to 28, vehicle 50 includes an interior 51 (in which the driver and passenger sit when the vehicle is moving), a passenger side door wind 44, a door top 42 that extends across and above the opening that is formed in the door for window 44, a front windshield 45, a rear windshield 46, a driver's side door 47, and a window 48 in the driver's side door. Dispensing unit 10B is mounted on the roof above the rear windshield 46. Dispensing unit 10A is mounted on the roof above the front windshield 45. A dispensing unit 10 is mounted on door top 42.

Mounting dispensing units 10, 10A, 10B, 10C, 10D on the exterior of a vehicle 40, 50 is important in the practice of the invention because the units 10, 10A, 10B, 10C, 10D are readily visible and recognizable and function as a deterrent. An individual viewing such units and considering directing small arms fire toward the vehicle 40, 50 will realize that it is unlikely the small arms fire will penetrate the glass laminate armor system that is produced in concert with units 10, 10A, etc. and is described below. As a result, it is believed that in at least some cases the presence of units 10, 10A, etc. on a vehicle 40, 50 will deter an individual from firing at the vehicle.

One important feature of the invention is that the glass utilized in the windows of a police vehicle 40, 50 (or other vehicle) be tempered glass or laminate glass or other glass constructs of increased strength. Laminate glass construction is illustrated in FIG. 29 and includes a layer 57 of polymer or another material(s) intermediate first 56 and second 58 sheets of glass. When the first or second sheets 56, 58 of glass break, the pieces of glass generally adhere to the polymer sheet.

Another important feature of the invention is that the glass utilized in the windows of a police vehicle 40, 50 be inwardly canted toward the interior 51 of the vehicle in the manner that windows 45, 44, 40D, 40C are inwardly canted toward the interior of the vehicle. The inward canting of the windows increases the likelihood that small arms fire indicated by arrow A in FIG. 29 will be upwardly deflected in the manner indicated by arrow B.

A further important feature of the invention is that the glass 45 utilized in the windows of a police vehicle 40, 50 have a convex shape and include an outer convex surface 59. Glass is stronger in compression. When an impact force generated in the direction of arrow A in FIG. 29 strikes window 45, the convex shape of the glass enables the glass to better dissipate forces over the glass in the manner indicated by arrows U, V, X, Y, Q, R, S, T in FIG. 30.

Another critical feature of the invention is that an armor sheet 25, 25A deployed by a dispensing unit drape over and contact at least a portion of the outer convex surface 59 of a window 45 in the manner illustrated in FIGS. 25 to 29. It is critical that armor sheet 25, 25A be deployed over the convex exterior surface of window 45 to form the glass laminate of the invention. When an armor sheet 25, 25A contacts a window 45, a glass laminate is formed which has greater than normal strength. One reason the glass laminate has greater than normal strength is that the armor sheet 25, 25A is not spaced apart from window 45. If the armor sheet were spaced apart from window 45, then small arms fire could impact the sheet 25, 25A against the window 45, increasing the likelihood that the window 45 would break. A second reason the glass laminate has greater than normal strength is that the armor sheet 25, 25A is canted inwardly, which increases the likelihood that small arms fire will be deflected in the direction of arrow B to decrease the forces generated by the small arms fire when it impact the glass laminate of the invention. A third reason the glass laminate has greater than normal strength is that the glass is canted inwardly to better deflect small arms fire in the manner indicated by arrow B in FIG. 29. A fourth reason the glass laminate has greater than normal strength is that both the armor sheet 25, 25A and the glass 45 in the glass laminate have a convex configuration that facilitates the dissipation of impact forces generated by small arms fire. A fifth reason the glass laminate has greater than normal strength is that when a hinged, articulating sheet 25, 25A is utilized, the multiple hinge construction helps to dissipate impact forces in the same manner that chainmail dissipates impact forces. A sixth reason that the glass laminate has greater than normal strength is that in one embodiment of the invention the sheet 25, 25A can slide over a window 45 and generate frictional forces that can help dissipate the impact forces of small arms fire.

Armor 25 can be constructed in any desired manner utilizing any desired material to prevent penetration by any selected weapon. In one embodiment of the invention, ballistic steel is utilized to construct armor 25. The steel is sufficiently thick to stop selected rifle bullets and AK47 or M16 bullets. In another embodiment of the invention, armor 25 is constructed of materials that will absorb and prevent the penetration by shrapnel during the detonation of selected ordinance.

In other embodiments of the invention, units 10 are mounted on jeeps, humvees, border patrol vehicles, ATF (Alcohol, Tobacco, and Firearm) vehicles, homeland security vehicles, and military vehicles.

Having described the invention in such terms as to enable those of skill in the art to make and practice it, and having described the presently preferred embodiments thereof, I Claim:

1. A method to protect a police officer receiving small arms fire, comprising the steps of:
(a) providing a pliable armor sheet of interconnected, hinged, articulating panels;
(b) manufacturing a driver's side door having a top, a window mounting space in said door beneath said top of said door, and a dispensing unit housing;
(c) providing a motorized police vehicle including a frame having an interior and a front, a plurality of ground engaging wheels rotatably attached to the frame and suspending the frame above the ground, and a windshield mounting space in said front of said frame and having a top;
(d) mounting said driver's side door in said police vehicle;
(e) mounting a first window in said window mounting space such that said window is canted inwardly toward said interior, said window comprising a convex panel of glass, including an outer convex surface, and selected from one of a pair comprising
(i) tempered glass, and
(ii) laminated glass including
an outer convex surface,
a first glass panel,
a second glass panel, and
a polymer sheet intermediate said first and second glass panels;
(f) mounting a second window in said windshield mounting space such that said second window is canted inwardly toward said interior, said window comprising a convex panel of glass, including an outer convex surface, and selected form one of a pair comprising
(i) tempered glass, and
(ii) laminated glass including
an outer convex surface,
a first glass panel,
a second glass panel, and
a polymer sheet intermediate said first and second glass panels;
(g) mounting said pliable armor sheet in said dispensing unit housing in a wound configuration in said driver's side door for deployment therefrom
(i) at an angle canted inwardly toward said interior of said frame,
(ii) to contact directly with said outer convex surface of one of a first pair comprising said first window and said second window, and
(iii) to form a canted convex small arms fire-resistant laminate comprising said armor sheet and said one of said first and second windows;
(h) driving said police vehicle to a location where small arms fire will be directed toward said vehicle;
(i) positioning said police vehicle such that said pliable sheet when deployed from said dispensing unit will receive at least some of said small arms fire directed toward said vehicle; and,
(j) deploying said pliable sheet from said dispensing unit to extend over and directly contact said convex outer surface of at least one of said first pair to form said canted convex small arms fire-resistant laminate.
